(19) United States
(12) Patent Application Publication
(10) Pub. No.: US 2025/0257772 A1
(43) Pub. Date: Aug. 14, 2025

(54) ELECTROMECHANICAL BRAKE WITH C-SHAPED RING BETWEEN BRAKE CALIPER HOUSING AND BRAKE CLAMP

(71) Applicant: Robert Bosch GmbH, Stuttgart (DE)

(72) Inventors: Dietmar Kratzer, Hersbruck (DE); Andreas Baecker, Bretzfeld (DE); Andrej Gardt, Abstatt (DE); Bernd Lutz, Kempten (DE); Florian Breyer, Suzhou (CN); Kornelius Loew, Schwaigern (DE); Mark Boehm, Lehrensteinsfeld (DE); Martin Winkler, Sonthofen (DE); Michael Kloss, Ilsfeld-Auenstein (DE)

(21) Appl. No.: 19/044,799

(22) Filed: Feb. 4, 2025

(30) Foreign Application Priority Data
Feb. 9, 2024 (DE) 10 2024 201 187.8

(51) Int. Cl. F16D 65/00; F16D 65/18; F16D 121/24

(52) U.S. Cl. CPC F16D 65/0075; F16D 65/18; F16D 2121/24

(57) ABSTRACT

An electromechanical brake for a motor vehicle. The electromechanical brake includes a brake clamp, which at least partially surrounds a brake disk, and a brake caliper housing, in which an adjusting unit driven by an electric motor is arranged, via which adjusting unit a braking force can be applied to a brake piston, so that a brake pad can be applied to the brake disk for braking. The brake caliper housing and the brake clamp are formed as separate components, wherein the brake caliper housing and the brake clamp each form a groove in a connecting region, wherein a C-shaped ring is provided, which is partially arranged in both grooves and blocks a relative movement of the brake clamp to the brake caliper housing at least when the braking force is applied.

### FIELD

The present invention relates to an electromechanical brake for a motor vehicle. In addition, the present invention relates to a motor vehicle having such an electromechanical brake.

### BACKGROUND INFORMATION

The service brake is usually a brake that uses brake fluid to press a brake piston together with a brake pad onto a brake disk in order to brake the vehicle. The parking brake, on the other hand, is designed as an electromechanical brake. As part of the increasing electrification of motor vehicle components, the service brake is also intended to be designed as an electromechanical brake, thereby making it possible to dispense with brake fluid and the associated complex valve and line structure. Such an electromechanical brake could also significantly reduce maintenance requirements.

European Patent No. EP 1 030 979 B1 describes an electromechanical brake device for braking a motor vehicle wheel. The brake device comprises a brake caliper, in which an electric motor is arranged. The electric motor drives a spindle drive unit, via which brake pads arranged on a brake clamp of the brake caliper can be applied to a brake disk for braking.

German Patent Application No. DE 10 2018 211 443 A1 describes a pressure generating device for a brake system of a vehicle.

U.S. Patent Application Publication No. US 2019/0003535 A1 relates to a clamp for a brake unit for overlapping the outside of a tensioning disk of a cabin, having an electric motor driving a rotary shaft, a first endless screw geared to a first primary gearwheel, and a second endless screw geared to a second primary gearwheel.

An object of the present invention is to provide an electromechanical brake for a motor vehicle that can be assembled more easily and economically.

The object may be achieved by an electromechanical brake for a motor vehicle having certain features of the present invention. Preferred example embodiments of the present invention are disclosed herein.

### SUMMARY

The present invention provides an electromechanical brake for a motor vehicle. The electromechanical brake comprises a brake clamp, which at least partially surrounds a brake disk, and a brake caliper housing, in which an adjusting unit driven by an electric motor is arranged, via which adjusting unit a braking force can be applied to a brake piston so that a brake pad can be applied to the brake disk for braking. The brake caliper housing and the brake clamp are formed as separate components, wherein the brake caliper housing and the brake clamp each form a groove in a connecting region, wherein a C-shaped ring is provided, which is partially arranged in both grooves and blocks a relative movement of the brake clamp to the brake caliper housing at least when the braking force is applied.

According to the present invention, the brake clamp and the brake caliper housing are formed from two separate parts. Accordingly, a lighter material, which is also easier to produce, can be used for the brake caliper housing. The connecting region is accordingly a region between the brake clamp and the brake caliper housing, in which they radially overlap and are fastened to each other. A C-shaped ring is understood to be a ring that is not completely closed. In other words, the ring has two ends which are spaced apart by a gap. Rings with different cross-sections can be used. Advantageously, however, the ring has a round cross-section. The gap has the advantage that the ring can be compressed for assembly and therefore has a smaller diameter. In the groove, the ring expands again, so that a permanent connection is formed between the brake caliper housing and the brake clamp.

By connecting the brake clamp to the brake caliper housing via such a C-shaped ring, they can be connected to each other without tools. This makes assembling the brake caliper housing with the C-shaped ring quick and easy. Assembly of the electromechanical brake is therefore more economical.

In a preferred embodiment of the present invention, positive-locking elements are formed in the connecting region of the brake caliper housing and the brake clamp in order to block rotation between the brake caliper housing and the brake clamp. Positive-locking elements are understood to be component elements on the brake caliper housing and the brake clamp which are formed in such a way that they positively interact with one another. This makes it possible to fix the brake caliper housing in a predetermined position relative to the brake clamp. By positioning the positive-locking elements in a predetermined manner, a desired angle between the brake caliper housing and the brake clamp can be set. This makes it possible to easily set an angle of rotation between the brake caliper housing and the brake clamp.

In a further preferred embodiment of the present invention, the positive-locking elements are formed as knurls on the brake caliper housing and on the brake clamp. A knurl is understood to comprise a plurality of teeth which run in the axial direction and are arranged on an outer diameter and inner diameter. The knurl of the brake caliper housing engages positively in the knurl of the brake clamp. The knurl design has the advantage that the brake caliper housing can be arranged at different angular alignments in relation to the brake clamp. The alignment of the brake caliper housing in relation to the brake clamp can therefore be variably adjusted depending on the installation situation. This means that separate components are not required for each angular position between the brake clamp and the brake caliper housing. This saves production costs for different versions of the brake caliper housing and the brake clamp. Only a single type of a brake clamp and of a brake caliper housing is thus necessary. This can reduce the production costs.

According to an example embodiment of the present invention, preferably, in the connecting region, the brake caliper housing and/or the brake clamp has at least one shoulder, via which a force opposing the braking force can be absorbed. A force opposing the braking force is a force of which the direction is opposite to a direction of the braking force. Such a force does not occur during a braking maneuver. The force opposing the braking force occurs, for example, when a brake pad adhering to the brake disk is pulled back therefrom after a prolonged standstill. In this case, the brake clamp and the brake caliper housing are pulled toward each other.

According to an example embodiment of the present invention, a shoulder can be designed in the form of a change in diameter. Such a shoulder allows the brake clamp and the brake caliper housing to support each other. As a result, such a shoulder can easily absorb forces that oppose the braking force.

In an advantageous development of the present invention, the groove of the brake caliper housing is delimited by a retaining ring on a side of the C-shaped ring that faces away from the brake clamp, which retaining ring is pressed onto the brake caliper housing and cooperates with the C-shaped ring in such a way that a force opposing the braking force can be absorbed via the retaining ring. Only forces that oppose the braking force would have to be absorbed via such a retaining ring. Since such forces are much lower than the braking forces, they can also be absorbed by the retaining ring. By delimiting the groove with a retaining ring, complex undercut manufacturing to form the groove can be dispensed with. The brake caliper housing can thus be formed more easily and economically.

Advantageously, the groove in the brake clamp and the brake caliper housing is formed in such a way that a force opposing the braking force can be absorbed via the grooves and the C-shaped ring. Advantageously, the groove is formed to be symmetrical. A separate shoulder for absorbing a force that opposes the braking force can be dispensed with. Such an electromechanical brake can therefore be produced more easily and economically.

In a further advantageous embodiment of the present invention, the groove is formed by a forming step. Preferably, the forming step is a forging step. The groove is thus not produced by machining. In contrast to machining, production via such a forming step is significantly lower in cost. Such an electromechanical brake can therefore be produced more economically. In contrast to machining, the forming step does not interrupt the fiber orientation in the workpiece. The durability and resilience of the workpiece are therefore improved.

The present invention also provides a motor vehicle comprising such an electromechanical brake according to the present invention. Such a motor vehicle has the above-described advantages and properties.

Exemplary embodiments of the present invention are illustrated in the figures and explained in more detail in the following description.

### BRIEF DESCRIPTION OF THE DRAWINGS

FIG. 1 is a sectional view of an electromechanical brake according to a first exemplary embodiment of the present invention.

FIG. 2 is a sectional view of the electromechanical brake according to a second exemplary embodiment of the present invention.

FIG. 3 is a perspective view of an exemplary embodiment of positive-locking elements on the brake caliper housing, according to the present invention.

FIG. 4 is a sectional view of the electromechanical brake according to a third and fourth exemplary embodiment of the present invention.

### DETAILED DESCRIPTION OF EXAMPLE EMBODIMENTS

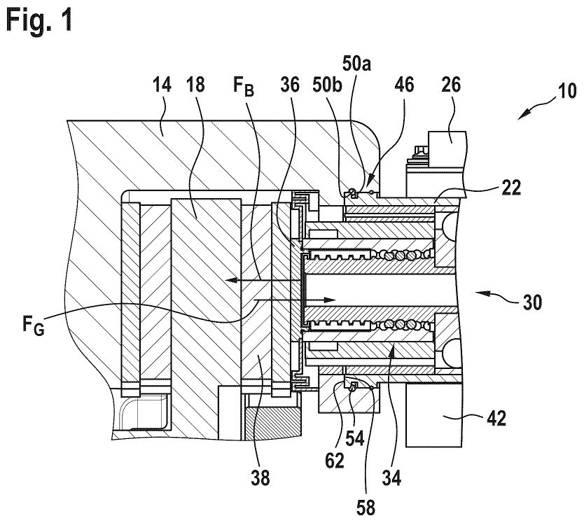

FIG. 1 is a sectional view of an electromechanical brake 10 according to a first exemplary embodiment of the present invention. The electromechanical brake 10 comprises a brake clamp 14, which partially surrounds a brake disk 18. In addition, the electromechanical brake 10 comprises a brake caliper housing 22, which is non-positively connected to the brake clamp 14. An electric motor 26 arranged on the brake caliper housing 22 drives an adjusting unit 30 arranged in the brake caliper housing 22. In the exemplary embodiment shown here, the adjusting unit 30 comprises a ball screw drive 34, via which a brake pad 38 is axially movable by means of a brake piston 36. The electric motor 26 is controlled via a control unit 42, which is also arranged on the brake caliper housing 22.

The brake caliper housing 22 and the brake clamp 14 are formed as separate parts. Accordingly, the brake caliper housing 22 and the brake clamp 14 can be formed of different materials. In a connecting region 46 between the brake clamp 14 and the brake caliper housing 22, both the brake clamp 14 and the brake caliper housing 22 form a radially opposite groove 50a, 50b. In this groove 50a, 50b, a C-shaped ring 54 is arranged, which fixes the brake caliper housing 22 and the brake clamp 14 in an assembled position. In the exemplary embodiment shown here, the C-shaped ring 54 has an annular cross-section. The C-shaped ring 54 is not completely closed, but has a gap (not shown). Through the gap, it is possible to compress the C-shaped ring 54, so that a diameter of the ring 54 is reduced. When reaching the groove 50b of the brake clamp, the ring 54 expands again, so that it is positioned in both grooves 50a, 50b.

In the exemplary embodiment shown in FIG. 1, it is possible via the C-shaped ring 54 to absorb a braking force F_{B} acting on the brake clamp 14. The brake clamp 14 forms a shoulder 58, on which an axial end 62 of the brake caliper housing 22 rests. Forces FG opposing the braking force F_{B} can be absorbed via this shoulder 58. Such forces F_{G} can occur, for example, when the brake pad 38 adhering to the brake disk 18 is actively pulled back therefrom after a prolonged standstill of the motor vehicle.

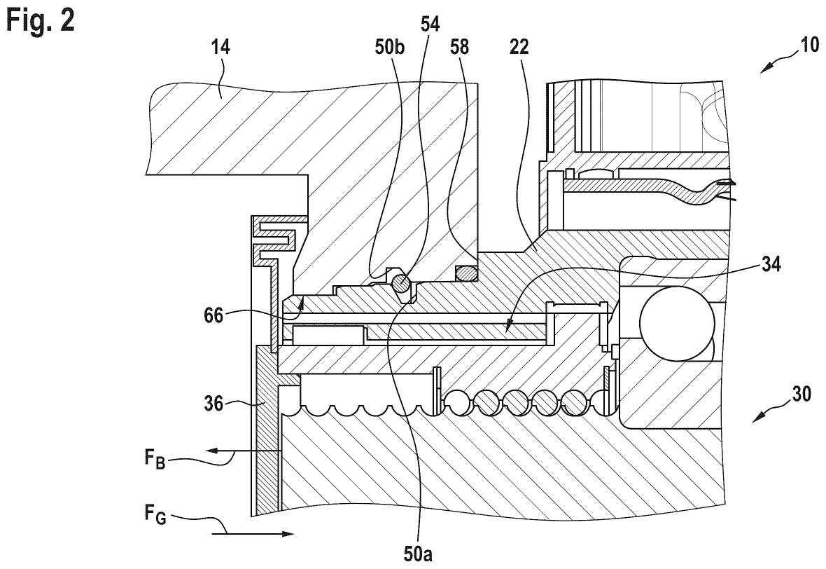

FIG. 2 is a sectional view of the electromechanical brake 10 according to a second exemplary embodiment of the present invention. The exemplary embodiment according to FIG. 2 differs from the exemplary embodiment in FIG. 1 in that a shoulder 58 is formed by the brake caliper housing 22 in this exemplary embodiment. The brake clamp 14 rests on this shoulder 58 so that forces F_{G} opposing the braking force F_{B} can be absorbed. In addition, in the connecting region 46 between the brake clamp 14 and the brake caliper housing 22, positive-locking elements 66 are formed, which block rotation between the brake caliper housing 22 and the brake clamp 14.

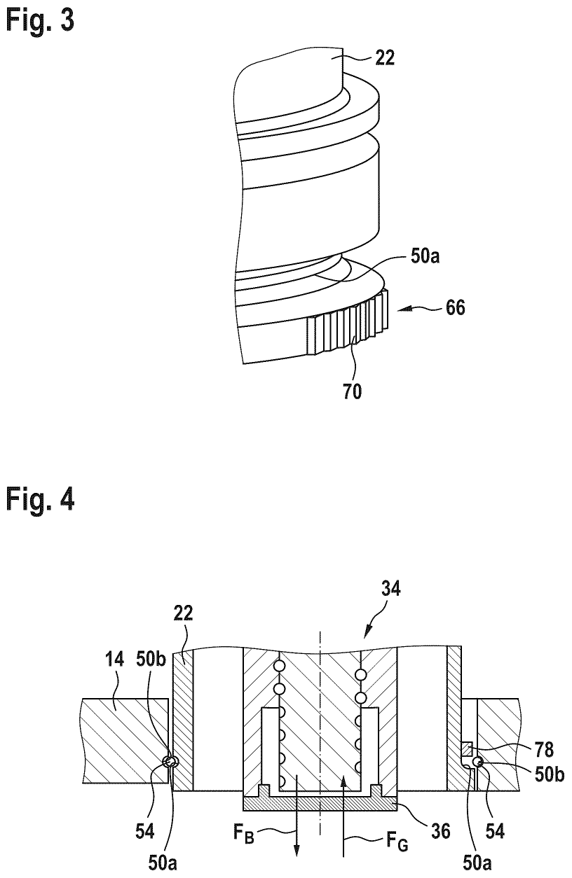

An exemplary embodiment of such a positive-locking element 66 is shown in FIG. 3. This figure shows a perspective view of the brake caliper housing 22. The positive-locking element 66 is designed in the form of a knurl here. Teeth 70 of the knurl 66 run in the axial direction of the brake caliper housing 22. A corresponding knurl 66 is also formed on the brake clamp 14. After assembling the brake caliper housing 22 on the brake clamp 14, the two knurls 66 engage in each other so that rotation is blocked. By forming the positive-locking elements 66 as a knurl, it is possible to set a different rotation between the brake clamp 14 and the brake caliper housing 22 for different installation positions.

FIG. 4 is a sectional view of the electromechanical brake 10 according to a third and fourth exemplary embodiment of the present invention. The third embodiment is shown on a left side of the electromechanical brake 10. In this exemplary embodiment, no shoulder 58 is formed. The groove 50a, 50b of the brake clamp 14 and of the brake caliper housing 22 is in each case semicircular, so that together they form an annular groove 50a, 50b for the C-shaped ring 54. Not only a braking force F_{B} but also a force F_{G} opposing the braking force is thus absorbed via the C-shaped ring 54. Accordingly, a shoulder 58 can be dispensed with.

The exemplary embodiment shown on the right side of the electromechanical brake 10 differs from the above-described exemplary embodiments in that the groove 50a formed on the brake caliper housing 22 is delimited only on one side. On a side of the C-shaped ring 54 that axially faces away from the brake clamp 14, a gap 74 is thus provided between the brake clamp 14 and the brake caliper housing 22. In this gap 74, a retaining ring 78 is applied to the brake caliper housing 22 on a side of the C-shaped ring 54 that axially faces away from the brake clamp 14. In the exemplary embodiment shown here, the retaining ring 78 is pressed onto the brake caliper housing 22. The groove 50a of the brake caliper housing 22 is thus delimited on this side by the retaining ring 78. The retaining ring 78 is accordingly arranged axially adjacent to the C-shaped ring 54. Both braking forces F_{B} and forces F_{G} opposing the braking forces F_{B} can thus be absorbed via such an arrangement.

1-8. (canceled)

9. An electromechanical brake for a motor vehicle, comprising:
a brake clamp, which at least partially surrounds a brake disk; and
a brake caliper housing, in which an adjusting unit driven by an electric motor is arranged, the adjusting unit configured to apply a braking force to a brake piston, so that a brake pad can be applied to the brake disk for braking;
wherein the brake caliper housing and the brake clamp are formed as separate components, the brake caliper housing and the brake clamp each including a groove in a connecting region, a C-shaped ring being provided, which is partially arranged in both of the grooves and blocks a relative movement of the brake clamp to the brake caliper housing at least when the braking force is applied.

10. The electromechanical brake according to claim 9, wherein, for blocking rotation between the brake caliper housing and the brake clamp, positive-locking elements are formed in the connecting region of the brake caliper housing and the brake clamp.

11. The electromechanical brake according to claim 10, wherein the positive-locking elements are formed as knurls on the brake caliper housing and on the brake clamp.

12. The electromechanical brake according to claim 9, wherein in the connecting region, the brake caliper housing and/or the brake clamp has at least one shoulder, via which a force opposing the braking force can be absorbed.

13. The electromechanical brake according to claim 9, wherein the groove of the brake caliper housing is delimited by a retaining ring on a side of the C-shaped ring that faces away from the brake clamp, the retaining ring being pressed onto the brake caliper housing and cooperating with the C-shaped ring in such a way that a force opposing the braking force can be absorbed via the retaining ring.

14. The electromechanical brake according to claim 9, wherein the groove in the brake clamp and the groove in the brake caliper housing are formed in such a way that a force opposing the braking force can be absorbed via the grooves and the C-shaped ring.

15. The electromechanical brake according to claim 9, wherein each of the grooves is formed by a forming step.

16. A motor vehicle, comprising:
an electromechanical brake, including:
a brake clamp, which at least partially surrounds a brake disk, and
a brake caliper housing, in which an adjusting unit driven by an electric motor is arranged, the adjusting unit configured to apply a braking force to a brake piston, so that a brake pad can be applied to the brake disk for braking,
wherein the brake caliper housing and the brake clamp are formed as separate components, the brake caliper housing and the brake clamp each including a groove in a connecting region, a C-shaped ring being provided, which is partially arranged in both of the grooves and blocks a relative movement of the brake clamp to the brake caliper housing at least when the braking force is applied.
